(19) United States
(12) Patent Application Publication
(10) Pub. No.: US 2020/0114181 A1
(43) Pub. Date: Apr. 16, 2020

(54) Harness With Adjustable Belt Strap

(71) Applicant: MSA Technology, LLC, Cranberry Township, PA (US)

(72) Inventors: Michael D. Monahan, Allison Park, PA (US); Mark Allen Hall, Cranberry Township, PA (US)

(21) Appl. No.: 16/599,908

(22) Filed: Oct. 11, 2019

Related U.S. Application Data
(60) Provisional application No. 62/745,034, filed on Oct. 12, 2018.

(51) Int. Cl. A62B 35/00

(52) U.S. Cl. CPC A62B 35/0031; A62B 35/0018

(57) ABSTRACT

A wearable body harness may include a first shoulder strap; a second shoulder strap; at least one adjustment mechanism having a first end connected to at least one of the first shoulder strap and the second shoulder strap and a free, second end opposite the first end; a belt strap connected to the first shoulder strap and the second shoulder strap via the at least one adjustment strap; and an adjustment mechanism configured for selectively raising or lowering a position of the belt strap relative to the first shoulder strap and the second shoulder strap. The adjustment mechanism may be connected to at least one of the first shoulder strap and the second shoulder strap. The second end of the at least one adjustment strap is connected to the adjustment mechanism.

### CROSS-REFERENCE TO RELATED APPLICATION

The present application claims priority to U.S. Provisional Application No. 62/745,034, filed Oct. 12, 2018, the disclosure of which is incorporated herein in its entirety.

### BACKGROUND

### Technical Field

The present disclosure relates generally to an adjustable belt strap and, in particular, an adjustable belt strap configured for use with a wearable body harness.

### Technical Considerations

As is known in the art, there exist various safety devices and arrangements that can be worn by or attached to a user to ensure the wearer's safety in certain situations. Such mechanisms come in many forms, including, but not limited to, harnesses and safety belts. Full body harnesses are widely used for lifting and lowering individuals in dangerous situations and as a primary component in a personal fall arrest system. These harnesses can also be used for work positioning, travel restriction, ladder climbing, rescue retrieval, and evacuation. While these harnesses are used mainly in an industrial setting, and particularly the construction industry where the likelihood and danger of falls from heights is both numerous and significant, a full body harness can be used in various other applications in which total suspension and support of the body must be ensured, either expectedly or unexpectedly.

While there are many variations in construction of wearable body harnesses, all typically include a plurality of elongate straps that are combined to fit around a user's body. In some non-limiting embodiments or aspects, a belt strap may be provided with the wearable body harness. The belt strap may be integrated with the harness, or it may be provided as a separate component that is worn together with the harness. The belt strap may be configured to support the lower area of the user's torso and/or allow for carrying of tools or other items. Typically, the belt strap is fixed relative to the straps of the harness. Such fixed arrangement may impair the user's ability to move freely because the belt strap may be positioned too high or too low relative to the user's beltline.

While a variety of harnesses with belt straps exist in the art, there is a continued need for improved harnesses with belt straps.

### SUMMARY

Generally, provided is an improved body harness having a harness back plate, a belt strap, and an improved strap arrangement.

In some non-limiting embodiments or aspects of the present disclosure, the wearable body harness may include a first shoulder strap and a second shoulder strap; at least one adjustment strap having a first end connected to at least one of the first shoulder strap and the second shoulder strap and a free, second end opposite the first end; a belt strap connected to the first shoulder strap and the second shoulder strap via the at least one adjustment strap; and an adjustment mechanism configured for selectively raising or lowering a position of the belt strap relative to the first shoulder strap and the second shoulder strap. The adjustment mechanism may be connected to at least one of the first shoulder strap and the second shoulder strap, and the second end of the at least one adjustment strap may be connected to the adjustment mechanism.

In some non-limiting embodiments or aspects, the adjustment mechanism may be an adjustment buckle configured to receive the second end of the at least one adjustment strap therethrough. Movement of the second end of the adjustment strap relative to the adjustment buckle may raise or lower the belt strap relative to the first shoulder strap and the second shoulder strap. The adjustment buckle may be operable between a locked state, in which the position of the second end of the adjustment strap is fixed relative to the adjustment buckle, and an unlocked state, in which the position of the second end of the adjustment strap relative to the adjustment buckle is adjustable.

In some non-limiting embodiments or aspects, in the locked state of the adjustment buckle, a strap clamp may frictionally engage the adjustment strap to prevent movement of the adjustment strap relative to the adjustment buckle. In the unlocked state of the adjustment buckle, the strap clamp may disengage from the adjustment strap to permit movement of the adjustment strap relative to the adjustment buckle. The belt strap may be suspended relative to the first shoulder strap and the second shoulder strap by the at least one adjustment strap. The wearable body harness may further include an adjustment plate connected to the belt strap and the least one adjustment strap, the adjustment plate having a first slot through which webbing of the belt strap is routed and a second slot through which the at least one adjustment strap is routed.

In some non-limiting embodiments or aspects, the belt strap may include at least one slot, wherein the at least one adjustment strap extends through the at least one slot. The adjustment mechanism may be a ladder latch having a first end, a second end a plurality of teeth extending between the first and second ends, and a locking piece having at least one pawl configured to engage with the plurality of teeth. The locking piece may be slidable along the ladder latch, and the second end of the at least one adjustment strap may be attached to the locking piece. A portion of the locking piece may be tiltable relative to the plurality of teeth, and the at least one pawl may extend from the tiltable portion of the locking piece and engage with the plurality of teeth thereby locking the locking piece against the plurality of teeth. By tilting the tiltable portion of the locking piece, the at least one pawl may disengage from the plurality of locking teeth permitting the locking piece to slide along the ladder latch. The sliding of the locking piece may raise or lower the belt strap relative to the first shoulder strap and the second shoulder strap. A position of the belt strap may be fixed relative to the first shoulder strap and the second shoulder strap when the locking piece is locked against the plurality of teeth. A position of the belt strap may be adjustable relative to the first shoulder strap and the second shoulder strap when the at least one pawl is disengaged with the plurality of teeth and the locking piece is unlocked.

In some non-limiting embodiments or aspects, an adjustable belt strap assembly configured for use with a wearable harness may include at least one adjustment strap having a first end configured for connecting to at least one strap of the wearable harness and a free, second end opposite the first end; a belt strap configured for being suspended from the at least one strap of the wearable harness via the at least one adjustment strap; and an adjustment mechanism configured for selectively raising or lowering a position of the belt strap relative to the at least one strap of the wearable harness. The adjustment mechanism may be configured to be connected to the at least one strap of the wearable harness, and the second end of the at least one adjustment strap is connected to the adjustment mechanism.

In some non-limiting embodiments or aspects, the adjustment mechanism may be an adjustment buckle configured to receive the second end of the at least one adjustment strap therethrough. The adjustment buckle may be operable between a locked state, in which the position of the second end of the adjustment strap is fixed relative to the adjustment buckle, and an unlocked state, in which the position of the second end of the adjustment strap relative to the adjustment buckle is adjustable. The adjustment mechanism may be a ladder latching having a first end, a second end, a plurality of teeth extending between the first and second ends, and a locking piece having at least one pawl configured to engage with the plurality of teeth. The locking piece may be slidable along the ladder latch, and the second end of the at least one adjustment strap may be attached to the locking piece. A portion of the locking piece may be tiltable relative to the plurality of teeth, and the at least one pawl may extend from the tiltable portion of the locking piece and may engage with the plurality of teeth thereby locking the locking piece against the plurality of teeth. By tilting the tiltable portion of the locking piece, the at least one pawl may disengage from the plurality of locking teeth permitting the locking piece to slide along the ladder latch and permitting the belt strap to raise or lower relative to the first shoulder strap and the second shoulder strap. The adjustable belt strap may further include an adjustment plate connected to the belt strap and the least one adjustment strap, the adjustment plate having a first slot through which webbing of the belt strap is routed and a second slot through which the at least one adjustment strap is routed.

Further non-limiting embodiments or aspects are set forth in the following numbered clauses.

Clause 1: A wearable body harness comprising: a first shoulder strap and a second shoulder strap; at least one adjustment strap having a first end connected to at least one of the first shoulder strap and the second shoulder strap and a free, second end opposite the first end; a belt strap connected to the first shoulder strap and the second shoulder strap via the at least one adjustment strap; and an adjustment mechanism configured for selectively raising or lowering a position of the belt strap relative to the first shoulder strap and the second shoulder strap, wherein the adjustment mechanism is connected to at least one of the first shoulder strap and the second shoulder strap, and wherein the second end of the at least one adjustment strap is connected to the adjustment mechanism.

Clause 2: The wearable body harness of clause 1, wherein the adjustment mechanism is an adjustment buckle configured to receive the second end of the at least one adjustment strap therethrough.

Clause 3: The wearable body harness of clause 1 or 2, wherein movement of the second end of the adjustment strap relative to the adjustment buckle raises or lowers the belt strap relative to the first shoulder strap and the second shoulder strap.

Clause 4: The wearable body harness of any of clauses 1-3, wherein the adjustment buckle is operable between a locked state, in which the position of the second end of the adjustment strap is fixed relative to the adjustment buckle, and an unlocked state, in which the position of the second end of the adjustment strap relative to the adjustment buckle is adjustable.

Clause 5: The wearable body harness of any of clauses 1-4, wherein, in the locked state of the adjustment buckle, a strap clamp frictionally engages the adjustment strap to prevent movement of the adjustment strap relative to the adjustment buckle.

Clause 6: The wearable body harness of any of clauses 1-5, wherein, in the unlocked state of the adjustment buckle, the strap clamp disengages from the adjustment strap to permit movement of the adjustment strap relative to the adjustment buckle.

Clause 7: The wearable body harness of any of clauses 1-6, wherein the belt strap is suspended relative to the first shoulder strap and the second shoulder strap by the at least one adjustment strap.

Clause 8: The wearable body harness of any of clauses 1-7, further comprising an adjustment plate connected to the belt strap and the least one adjustment strap, the adjustment plate having a first slot through which webbing of the belt strap is routed and a second slot through which the at least one adjustment strap is routed.

Clause 9: The wearable body harness of any of clauses 1-8, wherein the belt strap comprises at least one slot, and wherein the at least one adjustment strap extends through the at least one slot.

Clause 10: The wearable body harness of any of clauses 1-9, wherein the adjustment mechanism is a ladder latch having a first end, a second end, a plurality of teeth extending between the first and second ends, and a locking piece having at least one pawl configured to engage with the plurality of teeth, the locking piece slidable along the ladder latch, and wherein the second end of the at least one adjustment strap is attached to the locking piece.

=

Clause 11: The wearable body harness of any of clauses 1-10, wherein a portion of the locking piece is tiltable relative to the plurality of teeth, and wherein the at least one pawl extends from the tiltable portion of the locking piece and engages with the plurality of teeth thereby locking the locking piece against the plurality of teeth.

Clause 12: The wearable body harness of any of clauses 1-11, wherein by tilting the tiltable portion of the locking piece, the at least one pawl may disengage from the plurality of locking teeth permitting the locking piece to slide along the ladder latch, and wherein the sliding of the locking piece raises or lowers the belt strap relative to the first shoulder strap and the second shoulder strap.

Clause 13: The wearable body harness of any of clauses 1-12, wherein a position of the belt strap is fixed relative to the first shoulder strap and the second shoulder strap when the locking piece is locked against the plurality of teeth.

Clause 14: The wearable body harness of any of clauses 1-13, wherein a position of the belt strap is adjustable relative to the first shoulder strap and the second shoulder strap when the at least one pawl is disengaged with the plurality of teeth and the locking piece is unlocked.

Clause 15: An adjustable belt strap assembly configured for use with a wearable harness, the adjustable belt strap assembly including: at least one adjustment strap having a first end configured for connecting to at least one strap of the wearable harness and a free, second end opposite the first end; a belt strap configured for being suspended from the at least one strap of the wearable harness via the at least one adjustment strap; and an adjustment mechanism configured for selectively raising or lowering a position of the belt strap relative to the at least one strap of the wearable harness, wherein the adjustment mechanism is configured to be connected to the at least one strap of the wearable harness, and wherein the second end of the at least one adjustment strap is connected to the adjustment mechanism.

Clause 16: The adjustable belt strap assembly of clause 15, wherein the adjustment mechanism is an adjustment buckle configured to receive the second end of the at least one adjustment strap therethrough.

Clause 17: The adjustment belt strap assembly of clause 15 or 16, wherein the adjustment buckle is operable between a locked state, in which the position of the second end of the adjustment strap is fixed relative to the adjustment buckle, and an unlocked state, in which the position of the second end of the adjustment strap relative to the adjustment buckle is adjustable.

Clause 18: The adjustment belt strap assembly of any of clauses 15-17, wherein the adjustment mechanism is a ladder latch having a first end, a second end, a plurality of teeth extending between the first and second ends, and a locking piece having at least one pawl configured to engage with the plurality of teeth, the locking piece slidable along the ladder latch, and wherein the second end of the at least one adjustment strap is attached to the locking piece.

Clause 19: The adjustment belt strap assembly of any of clauses 15-18, wherein a portion of the locking piece is tiltable relative to the plurality of teeth, wherein the at least one pawl extends from the tiltable portion of the locking piece and engages with the plurality of teeth thereby locking the locking piece against the plurality of teeth, and wherein by tilting the tiltable portion of the locking piece, the at least one pawl may disengage from the plurality of locking teeth permitting the locking piece to slide along the ladder latch and permitting the belt strap to raise or lower relative to the first shoulder strap and the second shoulder strap.

Clause 20: The adjustment belt strap assembly of any of clauses 15-19, further comprising an adjustment plate connected to the belt strap and the least one adjustment strap, the adjustment plate having a first slot through which webbing of the belt strap is routed and a second slot through which the at least one adjustment strap is routed.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

FIG. 1A is a rear view of a wearable body harness and an adjustable belt strap in accordance with some non-limiting embodiments or aspects of the present disclosure;

FIG. 1B is a rear view of a wearable body harness and an adjustable belt strap in accordance with some non-limiting embodiments or aspects of the present disclosure;

FIG. 2 is a detailed rear view of a belt strap in accordance with some non-limiting embodiments or aspects of the present disclosure;

FIG. 3A is a detailed rear view of the adjustable belt strap and a portion of the wearable body harness shown in FIG. 1A;

FIG. 3B is a detailed rear view of the adjustable belt strap and a portion of the wearable body harness shown in FIG. 1B;

FIG. 4 is a detailed side view of the adjustable belt strap and wearable body harness of FIG. 3A taken along line A-A; and

FIG. 5 is a detailed side view of a user wearing a wearable body harness and an adjustable belt strap in accordance with some non-limiting embodiments or aspects of the present disclosure.

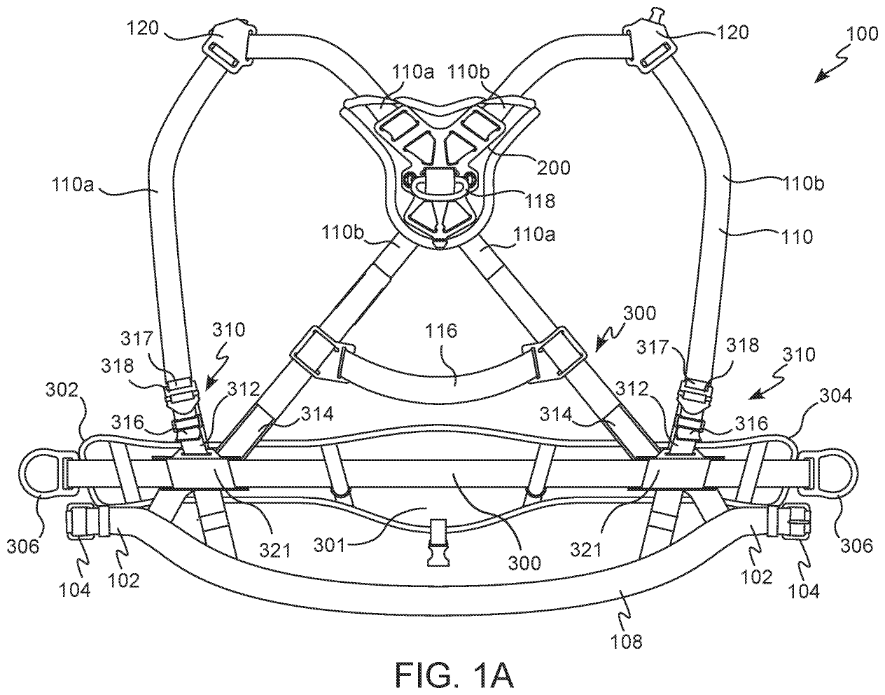

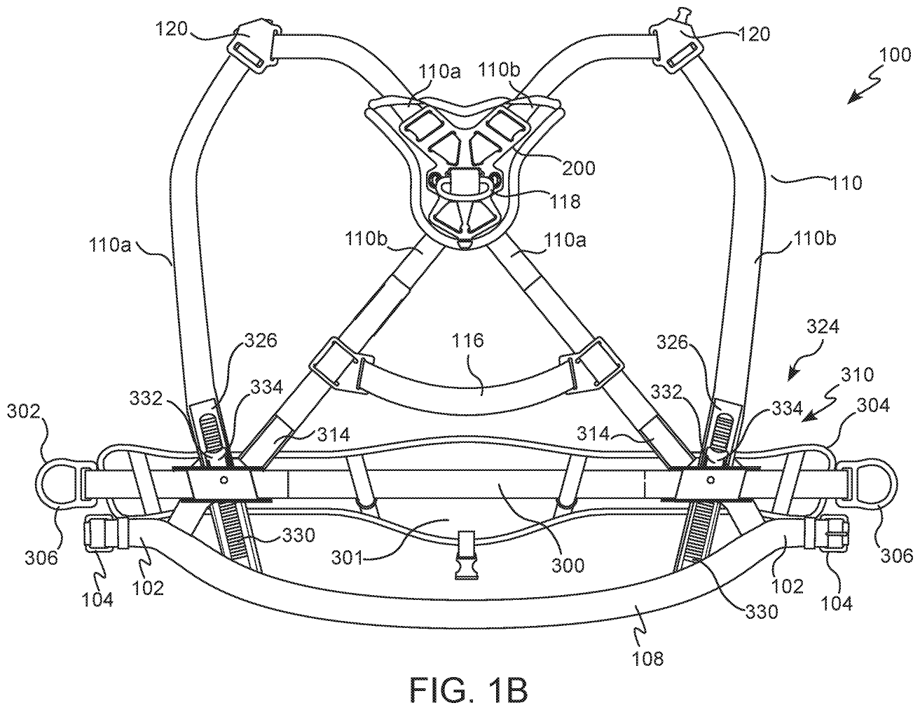

In FIGS. 1-5, like characters refer to the same components and elements unless otherwise stated.

### DETAILED DESCRIPTION

As used herein, the singular form of “a”, “an”, and “the” include plural referents unless the context clearly dictates otherwise.

Spatial or directional terms, such as “left”, “right”, “inner”, “outer”, “above”, “below”, and the like, relate to the embodiments or aspects as shown in the drawing figures and are not to be considered as limiting as the disclosure can assume various alternative orientations.

All numbers and ranges used in the specification and claims are to be understood as being modified in all instances by the term “about”. By “about” is meant plus or minus twenty-five percent of the stated value, such as plus or minus ten percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first”, “second”, and the like are not intended to refer to any particular order or chronology, but refer to different conditions, properties, or elements.

The term “at least” is synonymous with “greater than or equal to”.

The term “not greater than” is synonymous with “less than or equal to”.

As used herein, “at least one of” is synonymous with “one or more of”. For example, the phrase “at least one of A, B, and C” means any one of A, B, or C, or any combination of any two or more of A, B, or C. For example, “at least one of A, B, and C” includes A alone; or B alone; or C alone; or A and B; or A and C; or B and C; or all of A, B, and C.

The term “includes” is synonymous with “comprises”.

As used herein, the terms “parallel” or “substantially parallel” mean a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values.

As used herein, the terms “perpendicular” or “substantially perpendicular” mean a relative angle as between two objects at their real or theoretical intersection that is from 85° to 90°, or from 87° to 90°, or from 88° to 90°, or from 89° to 90°, or from 89.5° to 90°, or from 89.75° to 90°, or from 89.9° to 90°, inclusive of the recited values.

The discussion of the disclosure may describe certain features as being “particularly” or “preferably” within certain limitations (e.g., “preferably”, “more preferably”, or “even more preferably”, within certain limitations). It is to be understood that the disclosure is not limited to these particular or preferred limitations but encompasses the entire scope of the disclosure.

In some non-limiting embodiments or aspects, and with reference to FIGS. 1A-1B, the present disclosure is directed to a wearable safety harness 100 (hereinafter referred to as “harness 100”) used in a fall protection system. The harness 100 has a plurality of straps that are arranged to support the user's body in an event of a fall. The harness 100 has an adjustable belt strap configured to be moved independently relative to the straps of harness 100 to adjust a position of the belt strap on the user's body.

With continued reference to FIGS. 1A-1B, the harness 100 has at least two leg straps 102 configured to attach around a user's legs below a user's groin area. When attached, the leg straps 102 loop around or encircle each of the user's legs. Each leg strap 102 has a first end that is removably attachable to a second end via a connector 104. It is contemplated that the connector 104 may be any suitable connector known to those having skill in the art. For example, the connector 104 may be a buckle-type or a belt-type connector. In some non-limiting embodiments or aspects, the leg straps 102 may have at least one adjustment mechanism configured for adjusting the length of each leg strap 102. It is further contemplated that the adjustment mechanism may be any suitable adjustment mechanism known to those having skill in the art. For example, the adjustment mechanism 106 may be a sliding adjustment buckle.

Each leg strap 102 is connected to a seat strap 108 at an intermediate portion of the leg strap 102 between the first end and the second end. The seat strap 108 may extend across a user's lower back, buttocks, or an upper portion of the leg when the harness 100 is in use, depending on the user's size. Each leg strap 102 may be formed from a substantially flat webbing material typically used in harness construction, such as rayon, polyester, nylon or other materials known to those having skill in the art.

With continued reference to FIGS. 1A-1B, the harness 100 further has a pair of shoulder straps 110 configured to extend over at least a portion of the user's shoulders. The shoulder straps 110 may have a first shoulder strap 110a and a second shoulder strap 110b arranged to overlap one another in an X-shaped configuration, with the shoulder straps 110a, 110b configured to be connected at the user's chest area via a chest connector 120. Like the connector 104, the chest connector 120 may be any suitable connector, such as a buckle, known to those having skill in the art.

The shoulder straps 110a, 110b are configured to cross over each other at a rear portion of the harness 100 worn on the user's back. The harness 100 may have a back plate 200 through which the first shoulder strap 110a and the second shoulder strap 110b can be routed to maintain the first shoulder strap 110a and the second shoulder strap 110b in the X-shaped configuration. The first shoulder strap 110a may cross a longitudinal axis of the back plate 200 and the second shoulder strap 110b when forming an X-shaped configuration.

After the routing through the back plate 200, the shoulder straps 110a, 110b may extend downward and beyond the back plate 200 in generally opposite directions, maintaining the X-shaped configuration, until the first shoulder strap 110a and the second shoulder strap 110b reach the leg straps 102. Like the leg straps 102, the shoulder straps 110a, 110b may be formed from a substantially flat webbing material typically used in harness construction, such as rayon, polyester, nylon or other materials known to those having skill in the art.

As further shown in FIGS. 1A-1B, the harness 100 may have a back strap 116 connecting a substantially intermediate portion of the first shoulder strap 110a with a substantially intermediate portion of the second shoulder strap 110b. The back strap 116 may extend across a user's back to provide support and to maintain a set distance between the first shoulder strap 110a and the second shoulder strap 110b as they extend beyond the back plate 200 and down and along a user's back. The first and second shoulder straps 110a, 110b may be connectable together at a front portion of the harness 100 in an area of the user's chest. In some non-limiting embodiments or aspects, the first and second shoulder straps 110a, 110b may have at least one connection arrangement 120 or chest connector, such as a buckle, configured to releasably connect the first and second shoulder straps 110a, 110b to each other.

As further shown in FIGS. 1A-1B, the harness 100 has an anchor element, such as a D-ring 118, for connecting at least a portion of the shoulder straps 110a, 110b to a line fixed to an attachment, anchor point, or to a personal fall limiter device. The D-ring 118 has a frame defining at least one opening through which a clip, such as a carabiner, a lanyard, or other rope or line, can be secured to connect the harness 100 to the line or the personal fall limiter device. The D-ring 118 may be integrated with the back plate 200.

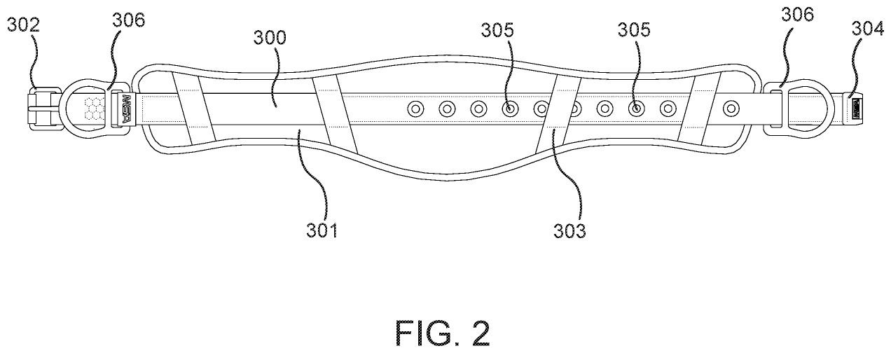

With reference to FIG. 2, and with continued reference to FIGS. 1A-1B, a belt strap 300 configured for use with the harness 100 is shown. The belt strap 300 is connected to the first and second shoulder straps 110a, 110b in an adjustable manner that allows for movement of the belt strap 300 relative to the first and second shoulder straps 110a, 110b. In this manner, the position of the belt strap 300 relative to the first and second shoulder straps 110a, 110b may be adjusted based on the needs of each individual user. The belt strap 300 described herein may be formed from a substantially flat webbing material typically used in belt and harness construction, such as rayon, polyester, nylon or other materials known to those having skill in the art.

In some non-limiting embodiments or aspects, the belt strap 300 may be configured for movement between at least two positions relative to the straps of the harness 100. For example, the belt strap 300 may be configured for movement to a first position relative to the first and second shoulder straps 110a, 110b, wherein the belt strap 300 is configured for use as a tool belt, and a second position, wherein the belt strap 300 is configured for use during work positioning. When used as a tool belt, a desired position of the belt strap 300 is around the waist and lumbar area, so that a portion of the weight of the tools can be supported by the user's hips and waist, with the belt strap 300 providing back support. When used for work positioning, the desired position of the belt strap 300 is below the waist near the level of the hips, thereby creating a padded area for the user to lean and “sit” into. The belt strap 300 may be secured to the harness 100, such as the first and second shoulder straps 110a, 110b, via an adjustment mechanism 310 (shown in FIGS. 1A-1B) that maintains the belt strap 300 in a fixed position relative to the first and second shoulder straps 110a, 110b. When it is desired to move or adjust the position of the belt strap 300 relative to the first and second shoulder straps 110a, 110b, the adjustment mechanism 310 may permit movement of the belt strap 300 relative to the first and second shoulder straps 110a, 110b, as described herein.

In use, the belt strap 300 is configured for extending around at least a portion of a user's waist. The belt strap 300 has a first end 302 opposite a second end 304. In some embodiments or aspects, the first end 302 may be removably connectable to the second end 304, such as via a connector or a buckle. In embodiments or aspects where the first and second ends 302, 304 have buckles, a plurality of holes 305 (only two labeled for clarity) may be provided along the belt 300 to permit connection with the buckle. The first and second ends 302, 304 may also have a connector 306, shown as a D-ring, from which tools or other items may be suspended. In other embodiments or aspects, the first end 302 may be spaced apart from the second end 304 when the belt strap 300 is worn by the user.

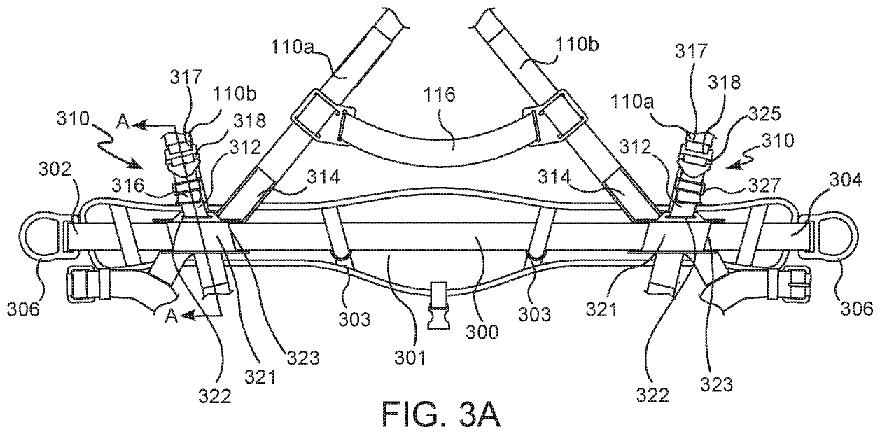

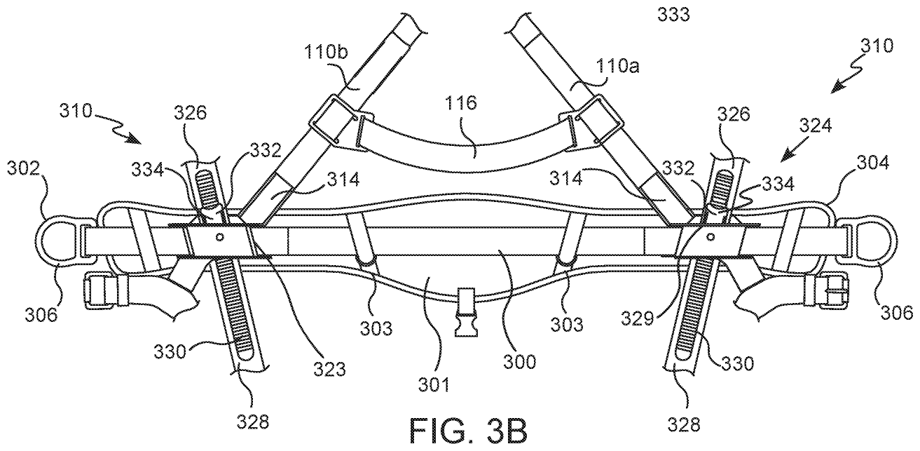

With continued reference to FIGS. 1A-2, the belt strap 300 may have a belt pad 301 that provides padding to increase user comfort while using the belt strap 300. As shown in FIG. 2 As shown in FIG. 2, the belt pad 301 has a plurality of support straps 303 for securing the belt strap 300 against the belt pad 301. The space between the belt strap 300 and the belt pad 301 may receive parts of a harness 100, such as first and second shoulder straps 110a, 110b. With reference to FIGS. 3A-3B, the adjustment mechanism 310 may be configured for selectively raising or lowering a position of the belt strap 300 relative to other straps of the harness 100 and locking the belt strap 300 at a desired position between a lowered position and a raised position. Desirably, the belt strap 300 has a pair of adjustment mechanisms 310 proximate to the first and second ends 302, 304 of the belt strap 300. Each adjustment mechanism 310 may have an adjustment strap 312 having a first end 314 attached to at least one of the first and second shoulder straps 110a, 110b and a second, free end 316 that extends under the belt strap 300. The first end 314 of the adjustment strap 312 may be sewn, adhered to, or otherwise connected to at least one of the first and second shoulder straps 110a, 110b. By moving the second, free end 316 in a first direction, such as by pulling in an upward direction, the belt strap 300 may be raised relative to the first and second shoulder straps 110a, 110b. Conversely, by moving the second, free end 316 in a second direction opposite to the first direction, such as by pulling in a downward direction, the belt strap 300 may be lowered relative to the first and second shoulder straps 110a, 110b.

With continued reference to FIGS. 3A-3B, the second end 316 of the adjustment strap 312 may be routed under the belt strap 300 through an opening in an adjustment plate 321 that is connected to the belt strap 300. In this manner, the belt strap 300 is suspended from the harness 100 via the adjustment strap 316. In some non-limiting embodiments or aspects, the adjustment plate 321 may have a first slot 323 through which the webbing of the belt strap 300 is routed and a separate, second slot 322 through which the adjustment strap 312 is routed. In some non-limiting embodiments or aspects, the adjustment plate 321 may be a D-ring fixedly connected to the belt strap 300 with the adjustment strap 312 being routed through the opening of the D-ring.

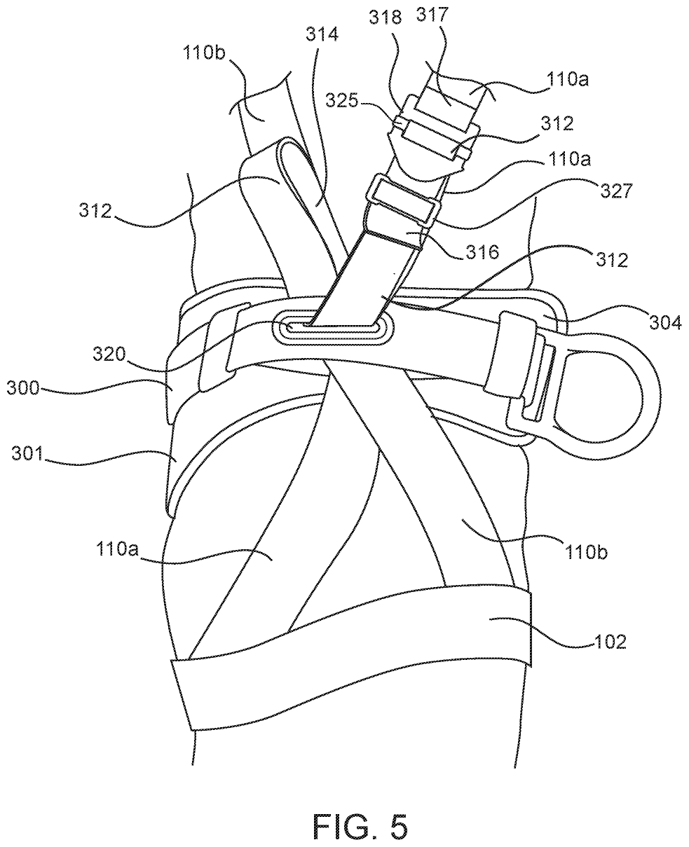

In some non-limiting embodiments or aspects, such as shown in FIG. 5, the adjustment plate 321 can be replaced with a slotted grommet 320 extending through the belt strap 300. The slotted grommet 320 has a width and height that is larger than a width and thickness of the adjustment strap 312 such that the adjustment strap 312 can freely move through the slotted grommet 320. The free, second end 316 of the adjustment strap 316 is routed through the slotted grommet 320 such that the belt strap 300 is suspended from the harness 100 via the adjustment strap 316.

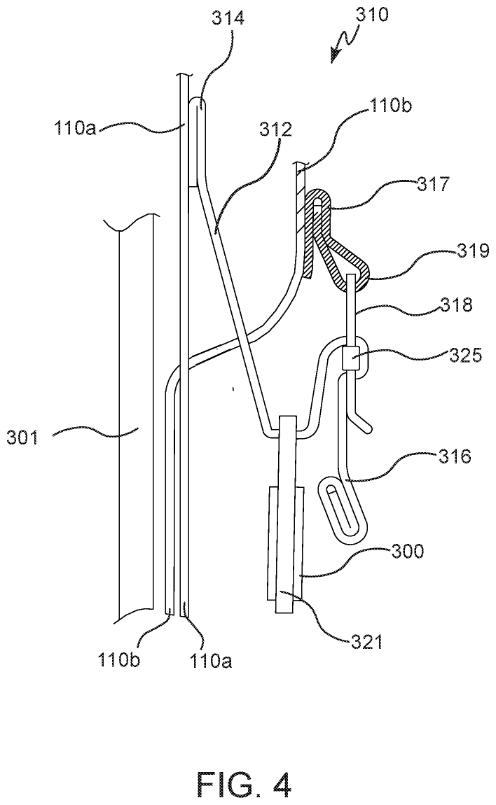

With reference to FIGS. 3A and 4, the adjustment mechanism 310 may include an adjustment buckle 318 that is connected to a front portion of one of the first or second shoulder straps 110a, 110b. The adjustment buckle 318 may be connected to one of the first or second shoulder straps 110a, 110b that is opposite to the other of the first or second shoulder straps 110a, 110b to which the first end 314 of the adjustment strap 312 is connected. In some non-limiting embodiments or aspects, the adjustment buckle 318 is directly connected to one of the first or second shoulder straps 110a, 110b. In some non-limiting embodiments or aspects, the adjustment buckle 318 is connected to one of the first or second shoulder straps 110a, 110b by way of a connecting strap 317. For example, the connecting strap 317 may be sewn, adhered to, or otherwise connected to one of the first or second shoulder straps 110a, 110b. As shown in FIG. 4, the connecting strap 317 may have a loop 319 configured to receive at least a portion of the adjustment buckle 318.

The adjustment buckle 318 is configured to receive the second end 316 of the adjustment strap 312 therethrough and permit selective movement of the adjustment strap 312, which in turn adjusts the position of the belt strap 300 relative to the harness 100. As shown in FIG. 4, the second end 316 of the adjustment strap 312 passes through the adjustment buckle 318 that is suspended from the connecting strap 317. The adjustment buckle 318 is operable between a locked state or configuration, in which the second end 316 of the adjustment strap 312 is fixed relative to the adjustment buckle 318, and an unlocked state or configuration, wherein the second end 316 of the adjustment strap 312 is movable relative to the adjustment buckle 318 to permit raising or lowering of the belt strap 300. The locking of the adjustment buckle 318 may be done by way of a strap clamp 325. The strap clamp 325 may be slidable on the adjustment buckle 318 between a first position and a second position. In the first position, the strap clamp 325 is retained tightly against the adjustment strap 312 so the second end 316 cannot move relative to the adjustment buckle 318. In the second position, the strap clamp 325 is moved away from the adjustment strap 312 so the second end 316 can move relative to the adjustment buckle 318. A strap hold 327 may be provided on one of the first or second shoulder straps 110a, 110b to prevent free movement of the second end 316 of the adjustment strap 312.

With reference to FIGS. 1B and 3B, the adjustment mechanism 310 may include a ladder latch 324 instead of the buckle 318. The ladder latch 324 a first end 326 and a second end 328 both attached to one of the first or second shoulder straps 110a, 110b. The first and second ends 326, 328 may be bolted, sewn, or tied to the first or second shoulder straps 110a, 110b. The first and second ends 326, 328 may be otherwise attached to the first or second shoulder straps 110a, 110b in another manner known to those having skill in the art. A plurality of teeth 330 (only one labeled for clarity) extend between the first and second ends 326, 328. A locking piece 332 is movable across the plurality of teeth 330, and lockable along any individual tooth 330. The locking piece 332 surrounds the ladder latch 324 and has a tiltable front portion 334 and a back portion (not shown). The front portion 334 may include one or more pawls that engage with one of the plurality of teeth 330 thereby locking the locking piece 332 at a desired location along the ladder latch 324. The tiltable front portion 334 is biased towards the plurality of teeth 330 so as to keep the pawls engaged with a tooth 330.

In order to adjust the position of the locking piece 332 along the plurality of teeth 330 of the ladder latch 324, a user may tilt the tiltable front portion 334 away from the plurality of teeth 330 thus disengaging the pawl from the tooth 330 to which it was engaged. While still tilting the front portion 334 away from the plurality of teeth 330, the user may slide the locking piece 332 upwards or downwards along length of the ladder latch 324. When the locking piece 332 is in a desired position, the user may release the tiltable front portion 334, so the pawls engage with a new tooth 330. This adjustment method can be used to move the locking piece 332 upwards or downwards along the length of the ladder latch 324.

After the second end 316 of the adjustment strap 312 is routed through the second slot 322 of the adjustment plate 321, the second end 316 is attached to the locking piece 332. The second end 316 may be attached to the back portion or a part of the tiltable front portion 334. It is contemplated that the second end 316 may be attached to the locking piece 332 in a manner known to those having skill in the art. In this configuration, as the locking piece 332 is moved along the length of the ladder latch 324, the adjustment strap 312 moves with the locking piece 332, raising and lowering the belt strap 300. In order to accommodate the ladder latch 324, the adjustment plate 321 may have a third slot 329 for receiving the ladder latch 324 and its respective components.

The adjustment mechanism 310 functions as a pulley, wherein the belt strap 300 can be raised or lowered by selectively moving the second end 316 of the adjustment strap 312 through the adjustment buckle 318 or the ladder latch 324 and locking the adjustment buckle 318 or locking piece 332 of the ladder latch 324 when the belt strap 300 is positioned at a desired orientation relative to the rest of the straps of the harness 100. In this configuration, the second slot 322 or the slotted grommet 320 acts as the pulley over which the adjustment strap 312 travels. When the adjustment strap 312 is pulled through the adjustment buckle 318 in a first direction or guided in a first direction by the locking piece 332 of the ladder latch 324, the belt strap 300 is raised relative to the harness 100 straps and the user. When the adjustment strap 312 is pulled through the adjustment buckle 318 in a second direction or guided in the second direction by the locking piece 332 of the ladder latch 324, the belt strap 300 is lowered relative to the harness 100 straps and the user.

Although the disclosure has been described in detail for the purpose of illustration based on what are currently considered to be the most practical, preferred, and non-limiting embodiments or aspects, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A wearable body harness comprising:
a first shoulder strap and a second shoulder strap;
at least one adjustment strap having a first end connected to at least one of the first shoulder strap and the second shoulder strap and a free, second end opposite the first end;
a belt strap connected to the first shoulder strap and the second shoulder strap via the at least one adjustment strap; and
an adjustment mechanism configured for selectively raising or lowering a position of the belt strap relative to the first shoulder strap and the second shoulder strap,
wherein the adjustment mechanism is connected to at least one of the first shoulder strap and the second shoulder strap, and
wherein the second end of the at least one adjustment strap is connected to the adjustment mechanism.

2. The wearable body harness of claim 1, wherein the adjustment mechanism is an adjustment buckle configured to receive the second end of the at least one adjustment strap therethrough.

3. The wearable body harness of claim 2, wherein movement of the second end of the adjustment strap relative to the adjustment buckle raises or lowers the belt strap relative to the first shoulder strap and the second shoulder strap.

4. The wearable body harness of claim 2, wherein the adjustment buckle is operable between a locked state, in which the position of the second end of the adjustment strap is fixed relative to the adjustment buckle, and an unlocked state, in which the position of the second end of the adjustment strap relative to the adjustment buckle is adjustable.

5. The wearable body harness of claim 4, wherein, in the locked state of the adjustment buckle, a strap clamp frictionally engages the adjustment strap to prevent movement of the adjustment strap relative to the adjustment buckle.

6. The wearable body harness of claim 5, wherein, in the unlocked state of the adjustment buckle, the strap clamp disengages from the adjustment strap to permit movement of the adjustment strap relative to the adjustment buckle.

7. The wearable body harness of claim 1, wherein the belt strap is suspended relative to the first shoulder strap and the second shoulder strap by the at least one adjustment strap.

8. The wearable body harness of claim 1, further comprising an adjustment plate connected to the belt strap and the least one adjustment strap, the adjustment plate having a first slot through which webbing of the belt strap is routed and a second slot through which the at least one adjustment strap is routed.

9. The wearable body harness of claim 1, wherein the belt strap comprises at least one slot, and wherein the at least one adjustment strap extends through the at least one slot.

10. The wearable body harness of claim 1, wherein the adjustment mechanism is a ladder latch having a first end, a second end, a plurality of teeth extending between the first and second ends, and a locking piece having at least one pawl configured to engage with the plurality of teeth, the locking piece slidable along the ladder latch, and wherein the second end of the at least one adjustment strap is attached to the locking piece.

11. The wearable body harness of claim 10, wherein a portion of the locking piece is tiltable relative to the plurality of teeth, and wherein the at least one pawl extends from the tiltable portion of the locking piece and engages with the plurality of teeth thereby locking the locking piece against the plurality of teeth.

12. The wearable body harness of claim 11, wherein by tilting the tiltable portion of the locking piece, the at least one pawl may disengage from the plurality of locking teeth permitting the locking piece to slide along the ladder latch, and wherein the sliding of the locking piece raises or lowers the belt strap relative to the first shoulder strap and the second shoulder strap.

13. The wearable body harness of claim 11, wherein a position of the belt strap is fixed relative to the first shoulder strap and the second shoulder strap when the locking piece is locked against the plurality of teeth.

14. The wearable body harness of claim 11, wherein a position of the belt strap is adjustable relative to the first shoulder strap and the second shoulder strap when the at least one pawl is disengaged with the plurality of teeth and the locking piece is unlocked.

15. An adjustable belt strap assembly configured for use with a wearable harness, the adjustable belt strap assembly comprising:
at least one adjustment strap having a first end configured for connecting to at least one strap of the wearable harness and a free, second end opposite the first end;
a belt strap configured for being suspended from the at least one strap of the wearable harness via the at least one adjustment strap; and
an adjustment mechanism configured for selectively raising or lowering a position of the belt strap relative to the at least one strap of the wearable harness,
wherein the adjustment mechanism is configured to be connected to the at least one strap of the wearable harness, and
wherein the second end of the at least one adjustment strap is connected to the adjustment mechanism.

16. The adjustable belt strap assembly of claim 15, wherein the adjustment mechanism is an adjustment buckle configured to receive the second end of the at least one adjustment strap therethrough.

17. The adjustable belt strap assembly of claim 16, wherein the adjustment buckle is operable between a locked state, in which the position of the second end of the adjustment strap is fixed relative to the adjustment buckle, and an unlocked state, in which the position of the second end of the adjustment strap relative to the adjustment buckle is adjustable.

18. The adjustable belt strap assembly of claim 15, wherein the adjustment mechanism is a ladder latch having a first end, a second end, a plurality of teeth extending between the first and second ends, and a locking piece having at least one pawl configured to engage with the plurality of teeth, the locking piece slidable along the ladder latch, and wherein the second end of the at least one adjustment strap is attached to the locking piece.

19. The adjustable belt strap assembly of claim 18, wherein a portion of the locking piece is tiltable relative to the plurality of teeth, wherein the at least one pawl extends from the tiltable portion of the locking piece and engages with the plurality of teeth thereby locking the locking piece against the plurality of teeth, and wherein by tilting the tiltable portion of the locking piece, the at least one pawl may disengage from the plurality of locking teeth permitting the locking piece to slide along the ladder latch and permitting the belt strap to raise or lower relative to the first shoulder strap and the second shoulder strap.

20. The adjustable belt strap assembly of claim 15, further comprising an adjustment plate connected to the belt strap and the least one adjustment strap, the adjustment plate having a first slot through which webbing of the belt strap is routed and a second slot through which the at least one adjustment strap is routed.
